(19) United States
(12) Patent Application Publication
(10) Pub. No.: US 2024/0049326 A1
(43) Pub. Date: Feb. 8, 2024

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/225,698

(22) Filed: Jul. 25, 2023

(30) Foreign Application Priority Data
Aug. 5, 2022 (CN) 202210943868.X
Aug. 9, 2022 (CN) 202210958255.3

(51) Int. Cl. H04W 76/19

(52) U.S. Cl. CPC H04W 76/19; H04W 92/10

(57) ABSTRACT

The present application discloses a method and a device for wireless communications. A first node receives a first message, the first message being used for configuring a first RLC entity and a second RLC entity; and transmits a first data unit set via the second RLC entity; and as a response to any condition in a first condition set being satisfied, starts to transmit a second data unit set via the first RLC entity; herein, each data unit comprised by the second RLC entity is transmitted via a second link in an air interface; the first condition set comprises that the second link is failed; each data unit comprised by the first RLC entity is transmitted via a first link in an air interface. The present application can enhance the robustness of data transmission with energy being saved.

### CROSS REFERENCE TO RELATED APPLICATIONS

This application claims the priority benefit of Chinese Patent Application No.202210940847.2, filed on Aug. 5, 2022, and claims the priority benefit of Chinese Patent Application No. 202210958255.3, filed on Aug. 9, 2022, the full disclosure of which is incorporated herein by reference.

### BACKGROUND

### Technical Field

The present application relates to methods and devices in wireless communication systems, and in particular to a method and device supporting multi-path transmission in wireless communications.

### Related Art

In response to rapidly developing Vehicle-to-Everything (V2X) traffics, Public safety traffics and commercial applications and services, the 3rd Generation Partner Project (3GPP) Radio Access Network (RAN) started a Study Item (SI) and a Work Item (WI) of standardization for “Study on NR (New Radio) Sidelink Relay” in Release 17, but due to the time limit, the R17 only supports a limited number of properties. To further support the Fifth Generation (5G) system enhancement, the Release 18 has started the 2nd stage study on ProSe, including the support for multi-path transmission. The multi-path transmission can include both direct path transmission and indirect path transmission, where in the direct path transmission there is only one-hop transmission between a source node and a destination receiving-node, while in the indirect path transmission there are multiple hops between a source node and a destination receiving-node. Herein, Relay is used as a multi-hop transmission technique that can enhance the throughput, the robustness and coverage. Data from the source node can arrive at the destination receiving-node through forwarding of a relay node (RN). The source node and the destination receiving-node are generally a base station and a UE, but sometimes they can be both UEs; the relay node can be a network device or a UE. Take the sidelink transmission in a Long Term Evolution (LTE) system as an example, the transmission from a User Equipment (UE) to a relay node uses the sidelink radio technique, and the transmission from a relay node to a base station or an eNodeB (eNB) uses the LTE radio technique, where the relay node is used for data forwarding between the UE and the eNB.

### SUMMARY

Inventors find through researches that in multi-path-supporting transmissions, when one of the multiple paths is failed, how to make a fast switch to another path to perform data transmissions, including retransmission, shall be studied.

To address the above issue, the present application provides a solution that can enhance the robustness of data transmission in an effective manner. In the case of no conflict, the embodiments of a first node and the characteristics in the embodiments may be applied to a second node, and vice versa. What's more, the embodiments in the present application and the characteristics in the embodiments can be arbitrarily combined if there is no conflict. Furthermore, though originally targeted at a Uu air interface, the present application is also applicable to a PC5 air interface. Furthermore, the present application is designed targeting terminal-base station scenario, but can be extended to relay-base station communications, where similar technical effects can be achieved. Additionally, the adoption of a unified solution for various scenarios, including but not limited to V2X and terminal-base station communications, contributes to the reduction of hardcore complexity and costs. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first message, the first message being used for configuring a first RLC entity and a second RLC entity; and
transmitting a first data unit set via the second RLC entity; and
as a response to any condition in a first condition set being satisfied, starting to transmit a second data unit set via the first RLC entity;
herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the present application is applicable to scenarios in which both sides of communications include one direct path and at least one indirect path.

In one embodiment, a source node and a destination node of communications can be a UE and a network, or two UEs.

In one embodiment, the present application illustrates with the source node and the destination node respectively being a UE and a network, but it can also be extended to UE-UE communication scenarios.

In one embodiment, the present application applies to dual connectivity transmission.

In one embodiment, the present application applies to multi-path transmission.

In one embodiment, the indirect path in the present application is forwarded via a UE-to-Network (U2N) relay.

In one embodiment, the indirect path in the present application is forwarded via a Layer 2 U2N relay.

In one embodiment, the indirect path in the present application is forwarded via a Layer 2 UE-to-UE (U2U) relay.

Typically, the second link is an indirect path, while the first link is a direct path.

In one embodiment, the above method of transmitting data unit(s) comprised by a first Packet Data Convergence Protocol (PDCP) entity via an indirect path can enhance the throughput ratio.

In one embodiment, the above method of transmitting data unit(s) comprised by a first Packet Data Convergence Protocol (PDCP) entity via an indirect path can reduce power consumption of the UE.

In one embodiment, the above method of transmitting data unit(s) comprised by a first Packet Data Convergence Protocol (PDCP) entity via an indirect path can enhance the transmission robustness.

In one embodiment, the above method of transmitting data unit(s) comprised by a first Packet Data Convergence Protocol (PDCP) entity via an indirect path can realize zero-delay for the path switch.

In one embodiment, an entity in the present application is a module.

In one embodiment, an entity in the present application is a module for completing a set of functions.

In one embodiment, an entity in the present application is a hardcore module for completing a set of functions.

In one embodiment, an entity in the present application is a softcore module for completing a set of functions.

In one embodiment, the relay node and the relay UE in the present application can be exchanged.

According to one aspect of the present application, comprising:
the first message indicates a first logical channel and a first RLC channel, where the first logical channel is associated with the first RLC entity, while the first RLC channel is associated with the second RLC entity.

In one embodiment, the first RLC channel corresponds to relay transmission.

According to one aspect of the present application, comprising:
receiving a first indication from the second RLC entity, the first indication being used for acknowledging a successful transmission of a first data unit subset;
herein, the second data unit set comprises at least one data unit in the first data unit subset, the first data unit set comprising the first data unit subset.

In one embodiment, the above method retransmits data units that have been acknowledged only in a first-hop transmission, which can avoid unsuccessful data transmission resulting from a failure of forwarding data units, thus enhancing the robustness of the data transmission.

According to one aspect of the present application, comprising:
a time interval from a reception of the first indication to the second link being acknowledged as failed is smaller than a first time length.

In one embodiment, the above method of retransmitting part of data units that has/have been acknowledged in a first-hop transmission can increase the utilization ratio of radio resources, avoiding invalid retransmission of any data unit that has been successfully transmitted.

According to one aspect of the present application, comprising:
when the second link is failed, transmitting second link failure information via the first link, the second link failure information indicating the second RLC entity.

According to one aspect of the present application, comprising:
when the second link is failed, re-establishing the second link;
and as a response to that re-establishing the second link is successful, stopping transmitting data unit(s) comprised by the first PDCP entity via the first RLC entity.

In one embodiment, as a response to that re-establishing the second link is successful, starting to transmit data unit(s) comprised by the first PDCP entity via the re-established second link.

In one embodiment, the above method prioritizes the choice of an indirect-path transmission when provided with an indirect path, which can enhance the system flexibility and effectively reduce the UE's energy consumption.

According to one aspect of the present application, comprising:
the first link is a direct path, while the second link is an indirect path; that the second link is failed includes at least one of the first sidelink being failed or a third link being failed;
herein, the third link is a link included in the second link other than the first sidelink.

The present application provides a method in a second node for wireless communications, comprising:
transmitting a first message, the first message being used for configuring a first RLC entity and a second RLC entity;
herein, a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

According to one aspect of the present application, comprising:
the first message indicating a first logical channel and a first RLC channel, where the first logical channel is associated with the first RLC entity, while the first RLC channel is associated with the second RLC entity.

According to one aspect of the present application, comprising:
a first indication from the second RLC entity being received, the first indication being used for acknowledging a successful transmission of a first data unit subset;
herein, the second data unit set comprises at least one data unit in the first data unit subset, the first data unit set comprising the first data unit subset.

According to one aspect of the present application, comprising:
a time interval from a reception of the first indication to the second link being acknowledged as failed is smaller than a first time length.

According to one aspect of the present application, comprising:
when the second link is failed, receiving second link failure information via the first link, the second link failure information indicating the second RLC entity.

According to one aspect of the present application, comprising:
when re-establishing the second link is successful, stopping receiving data unit(s) comprised by the first PDCP entity via a peer RLC entity of the first RLC entity; herein, the second link is failed and the second link is re-established.

According to one aspect of the present application, comprising:
the first link is a direct path, while the second link is an indirect path; that the second link is failed includes at least one of the first sidelink being failed or a third link being failed;
herein, the third link is a link included in the second link other than the first sidelink.

The present application provides a first node for wireless communications, comprising:
a first receiver, receiving a first message, the first message being used for configuring a first RLC entity and a second RLC entity; and
a first processor, transmitting a first data unit set via the second RLC entity; and as a response to any condition in a first condition set being satisfied, starting to transmit a second data unit set via the first RLC entity;
herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

The present application provides a second node for wireless communications, comprising:
a first transmitter, transmitting a first message, the first message being used for configuring a first RLC entity and a second RLC entity;
herein, a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of signal transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication device according to one embodiment of the present application.

FIG. 5 illustrates another flowchart of signal transmission of a first node according to one embodiment of the present application.

FIG. 6 illustrates a flowchart of radio signal transmission according to one embodiment of the present application.

FIG. 7 illustrates a third flowchart of signal transmission of a first node according to one embodiment of the present application.

FIG. 8 illustrates a schematic diagram of protocol structures of a first PDCP entity, a first RLC entity and a second RLC entity according to one embodiment of the present application.

FIG. 9 illustrates a schematic diagram of a radio protocol architecture of relay transmission according to one embodiment of the present application.

FIG. 10 illustrates a schematic diagram of a topological structure according to one embodiment of the present application.

FIG. 11 illustrates a structure block diagram of a processing device in a first node according to one embodiment of the present application.

FIG. 12 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

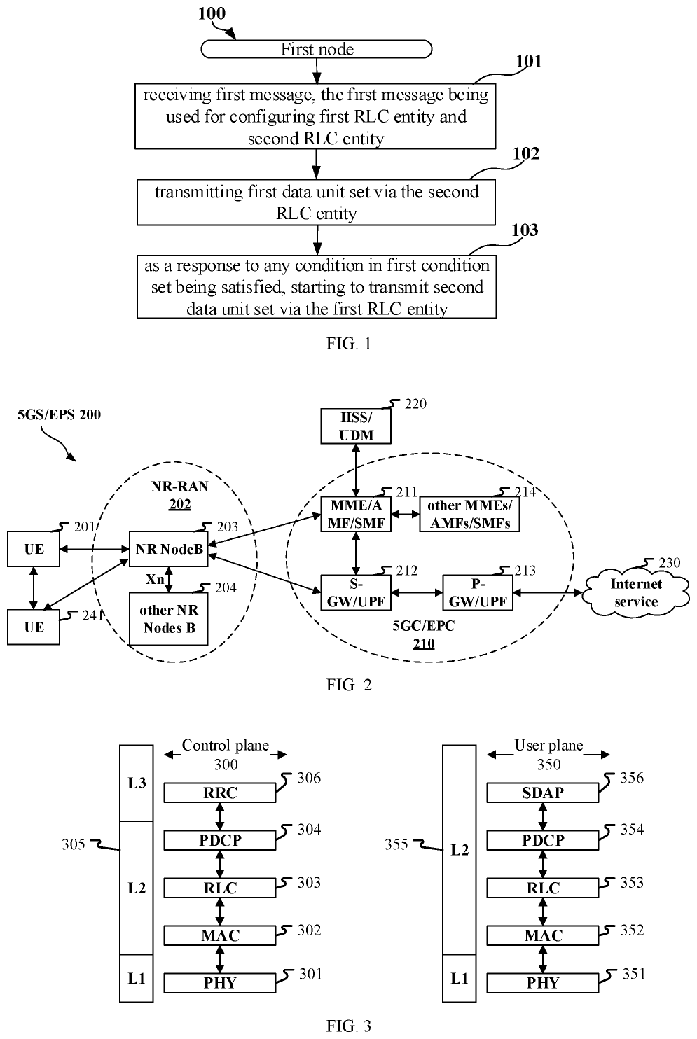

Embodiment 1 illustrates a flowchart of signal transmission of a first node according to one embodiment of the present application, as shown in FIG. 1.

In Embodiment 1, a first node 100 receives a first message in step 101, the first message being used for configuring a first RLC entity and a second RLC entity; and transmits a first data unit set via the second RLC entity in step 102; and in step 103, as a response to any condition in a first condition set being satisfied, starts to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set; the second link includes a first sidelink.

In one embodiment, a first message is received through an air interface.

In one embodiment, the air interface is a Uu air interface.

In one embodiment, the air interface is a PC5 air interface.

In one embodiment, the first message is an upper-layer message.

In one embodiment, the first message is a Radio Resource Control (RRC) signaling.

In one embodiment, the first message comprises all or part of Information Elements (IEs) in an RRC signaling.

In one embodiment, the first message comprises all or part of fields of an IE in an RRC signaling.

In one embodiment, the first message comprises a first sub-message and a second sub-message, the first sub-message and the second sub-message being respectively used for configuring the first Radio Link Control (RLC) entity and the second RLC entity.

In one embodiment, a first sub-message is received from the air interface, while the second sub-message is received from an upper layer of the first node.

In one subembodiment, the upper layer is used for storing pre-configuration information.

In one embodiment, the first sub-message and the second sub-message are respectively RRC signalings.

In one embodiment, the first sub-message and the second sub-message respectively comprise all or partial IEs in an RRC signaling.

In one embodiment, the first sub-message and the second sub-message respectively comprise all or partial fields of an IE in an RRC signaling.

In one embodiment, the first message comprises configuration information of the first RLC entity and configuration information of the second RLC entity.

In one embodiment, the configuration information of the first RLC entity at least comprises a working mode of the first RLC entity.

In one embodiment, the configuration information of the second RLC entity at least comprises a working mode of the second RLC entity.

In one embodiment, the first message indicates a first logical channel and a first RLC channel, where the first logical channel is associated with the first RLC entity, while the first RLC channel is associated with the second RLC entity.

In one embodiment, the first message comprises a first Logical Channel Identity (LCID) and a first RLC channel Identity, where the first LCID is used for identifying the first logical channel, while the first RLC channel Identity is used for identifying the first RLC channel.

In one embodiment, a logical channel being associated with an RLC entity means: an RLC entity conveying/receiving data to/from lower layers through a logical channel.

In one embodiment, an RLC channel being associated with an RLC entity means: an RLC entity receiving/conveying data from/to upper layers through an RLC channel.

In one embodiment, the first message indicates a first logical channel and a first RLC channel, where the first logical channel is used for identifying the first RLC entity at the network side, while the first RLC channel is used for identifying the second RLC entity at the network side.

In one embodiment, an information element (IE) for configuring the first RLC entity is an RLC-BearerConfig, the RLC-BearerConfig indicating the first logical channel

In one embodiment, an information element (IE) for configuring the second RLC entity is an SL-RLC-ChannelConfig, the SL-RLC-ChannelConfig indicating the first RLC channel.

In one embodiment, a first data unit set is transmitted by the second RLC entity, the first data unit set comprising at least one data unit.

In one embodiment, the data unit comprises an Internet Protocol (IP) data packet.

In one embodiment, the data unit comprises a Non-access stratum (NAS) control message.

In one embodiment, the data unit comprises an RRC signaling.

In one embodiment, the data unit comprises a PDCP Service Data Unit (SDU).

In one embodiment, the data unit comprises a PDCP Protocol Data Unit (PDU).

In one embodiment, the PDCP PDU comprises either a PDCP data PDU or a PDCP control PDU.

In one embodiment, the data unit comprises an RLC SDU.

In one embodiment, the data unit comprises an RLC SDU segment.

In one embodiment, each data unit comprised by the second RLC entity is transmitted via a second link in an air interface.

In one embodiment, each data unit comprised by the second RLC entity refers to: each data unit transmitted by the second RLC entity.

In one embodiment, the second link comprises at least two air interface links.

In one embodiment, the second link consists of at least two air interface links.

In one embodiment, the second link comprises a first sidelink.

In one embodiment, one of the at least two air interface links comprised by the second link is the first sidelink.

In one embodiment, the first sidelink is a Physical Sidelink Shared CHannel (PSSCH).

In one embodiment, the phrase of transmitting a first data unit set via the second RLC entity comprises: transmitting the first data unit set via the first sidelink.

In one embodiment, as a response to any condition in a first condition set being satisfied, starting to transmit a second data unit set via the first RLC entity.

In one embodiment, the first processor determines that any condition in a first condition set is satisfied; and as a response to any condition in a first condition set being satisfied, starts to transmit a second data unit set via the first RLC entity.

In one embodiment, the second data unit set comprises at least one data unit.

In one embodiment, the second data unit set comprises at least one data unit that does not belong to the first data unit set.

In one embodiment, the first data unit set and the second data unit set are orthogonal.

In one embodiment, the second data unit set comprises at least one data unit belonging to the first data unit set.

In one embodiment, the phrase of starting to transmit a second data unit set via the first RLC entity comprises: the first RLC entity being activated.

In one embodiment, the phrase of starting to transmit a second data unit set via the first RLC entity comprises: the first PDCP entity being activated to switch a path.

In one embodiment, the phrase of starting to transmit a second data unit set via the first RLC entity comprises: the first PDCP entity being activated to split an RLC entity.

In one embodiment, the phrase of starting to transmit a second data unit set via the first RLC entity comprises: the first PDCP entity being switched to a new path.

In one embodiment, the phrase of starting to transmit a second data unit set via the first RLC entity comprises: indicating to the first PDCP entity an activation of the first RLC entity.

In one embodiment, the phrase of starting to transmit a second data unit set via the first RLC entity comprises: indicating to the first PDCP entity that data unit(s) can be transmitted through the first RLC entity.

In one embodiment, the phrase of starting to transmit a second data unit set via the first RLC entity comprises: starting to transmit a second data unit set through a direct path.

In one embodiment, when none of conditions in the first condition set is satisfied, the first RLC entity is not used for transmitting the first data unit set.

In one embodiment, when none of conditions in the first condition set is satisfied, the first RLC entity is not used for transmitting data unit(s) of the first PDCP entity.

In one embodiment, when none of conditions in the first condition set is satisfied, data unit(s) of the first PDCP entity is(are) only transmitted by the second RLC entity.

In one embodiment, when none of conditions in the first condition set is satisfied, the first RLC entity is deactivated.

In one embodiment, when none of conditions in the first condition set is satisfied, the first RLC entity is suspended.

In one embodiment, when none of conditions in the first condition set is satisfied, the first RLC entity is configured to be in a dormant state, while the second RLC entity is configured to be in an active state.

In one embodiment, the first RLC entity and the second RLC entity are in an active state immediately after being configured.

In one embodiment, the first condition set comprises that the second link is failed.

In one subembodiment, when the above conditions are satisfied, stop transmitting data unit(s) of the first PDCP entity through the second RLC entity.

In one embodiment, the first condition set comprises that a total amount of a data volume in the first PDCP entity and RLC data volumes awaiting initial transmissions in the second RLC entity and the first RLC entity is equal to or greater than a first threshold.

In one subembodiment, when the above conditions are satisfied, continue transmitting data unit(s) of the first PDCP entity through the second RLC entity.

In one embodiment, the first condition set at least comprises two conditions, of which one is that the second link is failed; the other is that a total amount of a data volume in the first PDCP entity and RLC data volumes awaiting initial transmissions in the second RLC entity and the first RLC entity is equal to or greater than a first threshold.

In one subembodiment, when at least the condition that the second link is failed is satisfied, stop transmitting the data unit(s) of the first PDCP entity through the second RLC entity.

In one subembodiment, when only the condition that a total amount of a data volume in the first PDCP entity and RLC data volumes awaiting initial transmissions in the second RLC entity and the first RLC entity is equal to or greater than a first threshold is satisfied, continue transmitting data unit(s) of the first PDCP entity through the second RLC entity.

In one embodiment, the first threshold is network-configured.

In one embodiment, a name of the first threshold includes DataSplitThreshold.

In one embodiment, each data unit comprised by the first RLC entity is transmitted via a first link in an air interface.

In one embodiment, the first link only comprises one air interface link.

In one subembodiment, the air interface link is an Uplink (UL).

In one subembodiment, the air interface link is a Sidelink (SL).

In one embodiment, the first link is a Physical Uplink Shared Channel (PUSCH).

In one embodiment, the first PDCP entity comprises the first data unit set and the second data unit set.

In one embodiment, that the first PDCP entity comprises the first data unit set and the second data unit set means: transmitting the first data unit set and the second data unit set through the first PDCP entity.

In one embodiment, the first RLC entity and the second RLC entity are both associated with a first PDCP entity.

In one embodiment, that the first RLC entity and the second RLC entity are both associated with a first PDCP entity means: data unit(s) comprised by the first PDCP entity being transmitted through at least one of the first RLC entity or the second RLC entity.

In one embodiment, the first PDCP entity is a transmitting PDCP entity.

In one embodiment, the first PDCP entity is configured with multi-path.

In one embodiment, the first PDCP entity is configured with multi-connectivity.

In one embodiment, the first PDCP entity is configured with a path switch.

In one embodiment, the first PDCP entity is configured with a splitSecondaryPath.

In one embodiment, the first RLC entity and the second RLC entity are both in an RLC sublayer of the first node.

In one embodiment, the first PDCP entity is in a PDCP sublayer of the first node.

### Embodiment 2

Embodiment 2 illustrates a schematic diagram of a network architecture according to one embodiment of the present application, as shown in FIG. 2. FIG. 2 illustrates a network architecture 200 of NR 5G, Long-Term Evolution (LTE), and Long-Term Evolution Advanced (LTE-A) systems. The NR 5G or LTE, or LTE-A network architecture 200 may be called a 5G System/Evolved Packet System (5GS/EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS may be interconnected with other access networks. For simple description, the entities/interfaces are not shown. As shown in FIG. 2, the 5GS/EPS provides packet switching services. Those skilled in the art will find it easy to understand that various concepts presented throughout the present application can be extended to networks providing circuit switching services or other cellular networks. The NG-RAN comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The XnAP protocol for the Xn interface is used for transmitting control-plane messages of the wireless network, while the user-plane protocol for the Xn interface is used for transmitting user-plane data. The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN, the gNB 203 can be a satellite, an aircraft or a terrestrial base station relayed through the satellite. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, vehicle-mounted equipment, vehicle-mounted communication units, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching (PS) Streaming services.

In one embodiment, the UE 201 corresponds to a first node in the present application.

In one embodiment, the gNB203 corresponds to a second node in the present application.

In one embodiment, the UE 241 corresponds to a third node in the present application.

In one embodiment, the UE 201 is a User Equipment (UE).

In one embodiment, the UE 201 is a Layer 2 (L2) U2N remote UE.

In one embodiment, the UE 201 is a Layer 2 (L2) U2U remote UE.

In one embodiment, the UE 241 is a User Equipment (UE).

In one embodiment, the UE 241 is a relay node.

In one embodiment, the UE 241 is a L2 relay node.

In one embodiment, the UE 241 is a L2 U2N relay UE.

In one embodiment, the UE 241 is a L2 U2U relay UE.

In one embodiment, the gNB203 is a Macro Cell base station.

In one embodiment, the gNB203 is a Micro Cell base station.

In one embodiment, the gNB203 is a Pico Cell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment. In one embodiment, the gNB203 is a base station supporting large time-delay difference.

In one embodiment, the gNB203 is a piece of test equipment (e.g., a transceiving device simulating partial functions of the base station, or a signaling test instrument).

In one embodiment, a radio link from the UE201 to the gNB203 is an uplink, the uplink being used for performing uplink transmission.

In one embodiment, a radio link from the UE241 to the gNB203 is an uplink, the uplink being used for performing uplink transmission.

In one embodiment, a radio link from the gNB203 to the UE201 is a downlink, the downlink being used for performing downlink transmission.

In one embodiment, a radio link from the gNB203 to the UE241 is a downlink, the downlink being used for performing downlink transmission.

In one embodiment, a radio link between the UE201 and the UE241 is a sidelink, the sidelink being used for performing sidelink transmission.

In one embodiment, the UE201 and the gNB203 are connected by a Uu air interface.

In one embodiment, the UE241 and the gNB203 are connected by a Uu air interface.

In one embodiment, the UE 201 and the UE 241 are connected by a PC5 air interface.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 of a UE and a gNB is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection, and also support for handover of a UE between gNBs. The RLC sublayer 303 provides segmentation and reassembling of a packet, retransmission of a lost packet through an Automatic Repeat Request (ARQ), and detection of duplicate packets and protocol errors. The MAC sublayer 302 provides mappings between a logical channel and a transport channel as well as multiplexing of logical channels. The MAC sublayer 302 is also responsible for allocating between UEs various radio resources (i.e., resource block) in a cell. The MAC sublayer 302 is also in charge of Hybrid Automatic Repeat Request (HARQ) operation. In the control plane 300, The Radio Resource Control (RRC) sublayer 306 in the L3 layer is responsible for acquiring radio resources (i.e., radio bearer) and configuring the lower layer using an RRC signaling between the gNB and the UE. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between Quality of Service (QoS) streams and a Data Radio Bearer (DRB), so as to support diversified traffics. The radio protocol architecture of UE in the user plane 350 may comprise all or part of protocol sublayers of a SDAP sublayer 356, a PDCP sublayer 354, a RLC sublayer 353 and a MAC sublayer 352 in L2. Although not described in FIG. 3, the UE may comprise several higher layers above the L2 355, such as a network layer (i.e., IP layer) terminated at a P-GW of the network side and an application layer terminated at the other side of the connection (i.e., a peer UE, a server, etc.).

In one embodiment, the PDCP304 transmits/receives data to/from the RLC303 via an RLC channel.

In one embodiment, the PDCP354 transmits/receives data to/from the RLC353 via an RLC channel.

In one embodiment, the RLC303 transmits/receives data to/from the MAC302 via the logical channel.

In one embodiment, the RLC353 transmits/receives data to/from the MAC352 via the logical channel.

In one embodiment, the MAC302 transmits/receives data to/from the PHY301 via the transport channel.

In one embodiment, the MAC352 transmits/receives data to/from the PHY351 via the transport channel.

In one embodiment, entities of multiple sublayers of the control plane in FIG. 3 form a Signaling Radio Bearer (SRB) vertically.

In one embodiment, entities of multiple sublayers of the user plane in FIG. 3 form a Data Radio Bearer (DRB) vertically.

In one embodiment, entities of multiple sublayers of the user plane in FIG. 3 form an MBS Radio Bearer (MRB) vertically.

In one embodiment, the radio protocol architecture in FIG. 3 is applicable to a first node in the present application.

In one embodiment, the radio protocol architecture in FIG. 3 is applicable to a second node in the present application.

In one embodiment, the radio protocol architecture in FIG. 3 is applicable to a third node in the present application.

In one embodiment, the first data unit set in the present application is generated by the PDCP304 or the PDCP354.

In one embodiment, the second data unit set in the present application is generated by the PDCP304 or the PDCP354.

In one embodiment, the first message in the present application is generated by the RRC306.

In one embodiment, the first indication in the present application is generated by the RLC303 or the RLC353.

In one embodiment, the second link failure information in the present application is generated by the RRC306.

In one embodiment, the first PDCP entity is in the PDCP304, and the first RLC entity and the second RLC entity are both in the RLC303.

In one embodiment, the first PDCP entity is in the PDCP354, and the first RLC entity and the second RLC entity are both in the RLC353.

In one embodiment, a data packet is called a PDCP PDU at a PDCP sublayer interface and an RLC SDU at an RLC sublayer interface, namely, a PDCP sublayer conveys a PDCP PDU to an RLC sublayer and the RLC sublayer receives an RLC SDU from the PDCP sublayer; an RLC sublayer conveys an RLC SDU to a PDCP sublayer and the PDCP sublayer receives a PDCP PDU from the RLC sublayer.

In one embodiment, the L2 305 or 355 belongs to higher layers.

In one embodiment, the RRC sublayer 306 in the L3 belongs to a higher layer.

### Embodiment 4

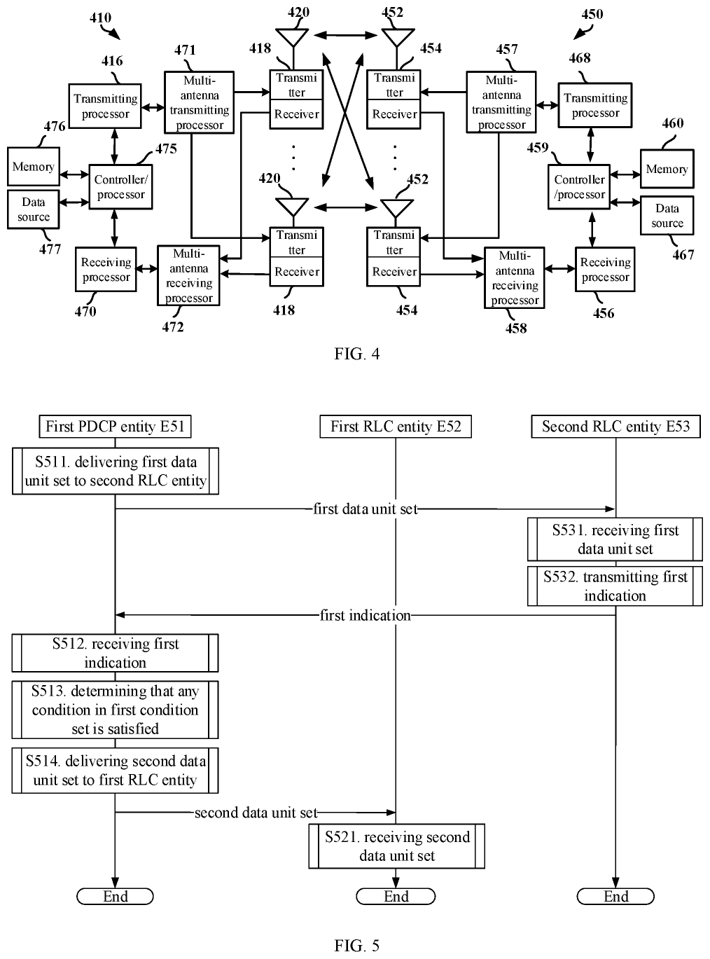

Embodiment 4 illustrates a schematic diagram of hardcore modules in a communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network or from a data source 477 is provided to the controller/processor 475. The core network and data source 477 represents all protocol layers above the L2 layer. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decrypting, header decompression, control signal processing so as to recover a higher-layer packet from the second communication device 410. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the LI layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device 450. The higher-layer packet coming from the controller/processor 475 may be provided to the core network, or all protocol layers above the L2, or, various control signals can be provided to the core network or L3 for processing.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first message, the first message being used for configuring a first RLC entity and a second RLC entity; and transmits a first data unit set via the second RLC entity; and as a response to any condition in a first condition set being satisfied, starts to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the first communication device 450 comprises a memory that stores a computer readable instruction program, the computer readable instruction program generates actions when executed by at least one processor, which include: receiving a first message, the first message being used for configuring a first RLC entity and a second RLC entity; and transmitting a first data unit set via the second RLC entity; and as a response to any condition in a first condition set being satisfied, starting to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first message, the first message being used for configuring a first RLC entity and a second RLC entity; herein, a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the second communication device 400 comprises a memory that stores a computer readable instruction program, the computer readable instruction program generates actions when executed by at least one processor, which include: transmitting a first message, the first message being used for configuring a first RLC entity and a second RLC entity; herein, a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the first communication device 450 corresponds to the first node in the present application.

In one embodiment, the first communication device 450 is a UE.

In one embodiment, the first communication device 450 is a L2 U2N remote UE.

In one embodiment, the first communication device 450 is a L3 relay node.

In one embodiment, the first communication device 450 is a base station.

In one embodiment, the second communication device 410 corresponds to the second node in the present application.

In one embodiment, the second communication device 410 is a base station.

In one embodiment, the second communication device 410 corresponds to the third node in the present application.

In one embodiment, the second communication device 410 is a L2 U2N relay UE.

In one embodiment, at least one of the antenna 420, the transmitter 418, the multi-antenna transmitting processor 471, the transmitting processor 416 or the controller/processor 475 is used for transmitting a first message in the present application.

In one embodiment, at least one of the antenna 452, the receiver 454, the multi-antenna receiving processor 458, the receiving processor 456 or the controller/processor 459 is used for receiving a first message in the present application.

In one embodiment, at least one of the antenna 452, the transmitter 454, the multi-antenna transmitting processor 457, the transmitting processor 468 or the controller/processor 459 is used for transmitting a first data unit set in the present application.

In one embodiment, at least one of the antenna 420, the receiver 418, the multi-antenna receiving processor 472, the receiving processor 470 or the controller/processor 475 is used for receiving a first data unit set in the present application.

In one embodiment, at least one of the antenna 452, the transmitter 454, the multi-antenna transmitting processor 457, the transmitting processor 468 or the controller/processor 459 is used for transmitting a second data unit set in the present application.

In one embodiment, at least one of the antenna 420, the receiver 418, the multi-antenna receiving processor 472, the receiving processor 470 or the controller/processor 475 is used for receiving a second data unit set in the present application.

In one embodiment, at least one of the antenna 452, the receiver 454, the multi-antenna receiving processor 458, the receiving processor 456 or the controller/processor 459 is used for receiving a first indication in the present application.

In one embodiment, at least one of the antenna 452, the transmitter 454, the multi-antenna transmitting processor 457, the transmitting processor 468 or the controller/processor 459 is used for transmitting second link failure information in the present application.

In one embodiment, at least one of the antenna 420, the receiver 418, the multi-antenna receiving processor 472, the receiving processor 470 or the controller/processor 475 is used for receiving second link failure information in the present application.

In one embodiment, at least one of the antenna 452, the transmitter 454, the multi-antenna transmitting processor 457, the transmitting processor 468 or the controller/processor 459 is used for re-establishing a second link.

In one embodiment, at least one of the antenna 452, the receiver 454, the multi-antenna receiving processor 458, the receiving processor 456, or the controller/processor 459 is used for re-establishing a second link.

In one embodiment, at least one of the antenna 420, the transmitter 418, the multi-antenna transmitting processor 471, the transmitting processor 416 or the controller/processor 475 is used for re-establishing a second link.

In one embodiment, at least one of the antenna 420, the receiver 418, the multi-antenna receiving processor 472, the receiving processor 470 or the controller/processor 475 is used for re-establishing a second link.

### Embodiment 5

Embodiment 5 illustrates another flowchart of signal transmission of a first node according to one

embodiment of the present application, as shown in FIG. 5. In FIG. 5, a first PDCP entity E51, a first RLC entity E52 and a second RLC entity E53 are all located in a first node, where the first PDCP entity E51 and the first RLC entity E52 are in communications via an inter-layer interface, and the first PDCP entity E51 and the second RLC entity E53 are in communications via an inter-layer interface.

The first PDCP entity E51 delivers a first data unit set to a second RLC entity in step S511; and receives a first indication in step S512; determines that any condition in a first condition set is satisfied in step S513; and delivers a second data unit set to a first RLC entity in step S514.

The first RLC entity E52 receives a second data unit set in step S521.

The second RLC entity E53 receives a first data unit set in step S531; and transmits a first indication in step S532.

Steps taken in Embodiment 5 are applicable to scenarios where the condition that a second link is failed is satisfied.

It should be noted that the step S512 can be performed after the step S513.

In one embodiment, when the first sidelink is failed, the step S512 is performed before the step S513; when the third link is failed, the step S512 is performed before the step S513 or the step S512 is performed after the step S513.

In Embodiment 5, receiving a first message, the first message being used for configuring a first RLC entity and a second RLC entity; and transmitting a first data unit set via the second RLC entity; and as a response to any condition in a first condition set being satisfied, starting to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink; receiving a first indication from the second RLC entity, the first indication being used for acknowledging a successful transmission of a first data unit subset; herein, the second data unit set comprises at least one data unit in the first data unit subset; the first data unit set comprises the first data unit subset; a time interval from a reception of the first indication to the second link being acknowledged as failed is smaller than a first time length; the first link is a direct path, while the second link is an indirect path; that the second link is failed includes at least one of the first sidelink being failed or a third link being failed; herein, the third link is a link included in the second link other than the first sidelink.

In one embodiment, the first PDCP entity receives a first indication from the second RLC entity.

In one embodiment, the first indication is used for confirming a successful transmission of a first data unit subset.

In one embodiment, the first indication is an inter-layer indication.

In one embodiment, the first indication comprises a sequence number (SN) of each data unit in the first data unit subset.

In one embodiment, a PDCP data PDU comprises a PDCP sequence number (SN), where the data unit is a PDCP data PDU.

In one embodiment, the PDCP sequence number (SN) is a non-negative integer.

In one embodiment, an RLC SDU is associated with one RLC sequence number (SN), where the data unit is an RLC SDU.

In one embodiment, an RLC SDU segment is associated with one RLC sequence number (SN), where the data unit is an RLC SDU segment.

In one embodiment, the second RLC entity sends a poll to a peer RLC entity of the second RLC entity, the poll being used for triggering a feedback of a STATUS PDU by the peer RLC entity of the second RLC entity.

In one embodiment, the STATUS PDU indicates whether the first data unit set is successfully transmitted.

In one embodiment, a STATUS PDU is received from the peer RLC entity of the second RLC entity, the STATUS PDU indicating a positive acknowledgement for each data unit in the first data unit subset, the second RLC entity sending the first indication to the first PDCP entity; herein, the first data unit set comprises a PDCP PDU.

In one embodiment, the peer RLC entity of the second RLC entity is in a node other than the first node.

In one embodiment, the first node and a node other than the first node are non-Quasi-Co-located (non-QCL).

In one embodiment, the first node and a node other than the first node are in connection via an air interface.

In one embodiment, the first node and a node other than the first node are in connection via a wired link.

In one embodiment, the second RLC entity is an Acknowledged Mode (AM) RLC entity.

In one subembodiment, the second RLC entity consists of a transmitting side and a receiving side.

In one embodiment, the first RLC entity is an AM RLC entity.

In one subembodiment, the first RLC entity consists of a transmitting side and a receiving side.

In one embodiment, the first RLC entity is an Unacknowledged Mode (UM) RLC entity.

In one Embodiment, the first RLC entity is a Transparent Mode (TM) RLC entity.

In one subembodiment of the above two embodiments, the first RLC entity is configured as a transmitting RLC entity.

In one embodiment, the first data unit set comprises the first data unit subset.

In one embodiment, any data unit in the first data unit subset belongs to the first data unit set.

In one embodiment, the first data unit subset is a subset of the first data unit set.

In one embodiment, the second data unit set comprises data unit(s) not having been acknowledged as being successfully transmitted in the first data unit set.

In one embodiment, the second data unit set comprises at least one data unit that does not belong to the first data unit set.

In one embodiment, when a time interval from a reception of the first indication to the second link being acknowledged as failed is smaller than the first time length, the second data unit set comprises at least one data unit in the first data unit subset.

In one embodiment, when a time interval from a reception of the first indication to the second link being acknowledged as failed is smaller than the first time length, the second data unit set comprises the first data unit subset.

In one embodiment, when a time interval from a reception of the first indication to the second link being acknowledged as failed is smaller than the first time length, the second data unit set comprises partial data units in the first data unit subset.

In one embodiment, the first processor randomly selects part of data units from the first data unit subset for retransmission.

In one embodiment, the first PDCP entity is configured with PDCP recovery.

In one embodiment, when a time interval from a reception of the first indication to the second link being acknowledged as failed is equal to the first time length, the second data unit set comprises at least one data unit in the first data unit subset.

In one embodiment, when a time interval from a reception of the first indication to the second link being acknowledged as failed is larger than the first time length, the second data unit set does not comprise any data unit in the first data unit subset.

In one embodiment, the first processor, as a response to receiving the first indication, starts or restarts a first timer; when it is determined that the second link is failed as the first timer is running, the second data unit set comprises at least one data unit in the first data unit subset; when it is determined that the second link is failed after the first timer is expired, the second data unit set does not comprise any data unit in the first data unit subset; herein, a duration indicated by an expiration value of the first timer is the first time length, upon expiration the first timer stops running.

In one embodiment, the first processor receives a first indication from the second RLC entity, the first indication being used for acknowledging a successful transmission of a first data unit subset; any data unit in the second data unit set does not belong to the first data unit subset, the first data unit set comprising the first data unit subset; a time interval from a reception of the first indication to the second link being acknowledged as failed is no smaller than a first time length.

In one embodiment, the first time length is configurable.

In one embodiment, the first time length is configured by a serving cell of the first node.

In one embodiment, the first time length is pre-configured.

In one embodiment, the first timer is maintained in the first PDCP entity.

In one embodiment, the first time length is variable.

In one embodiment, the first time length is fixed.

In one embodiment, the first time length is related to a number of L2 relay node(s) comprised within a distance from a node in which the peer RLC entity of the second RLC entity is comprised to a destination/target receiver of the first data unit set.

In one embodiment, a node in which the peer RLC entity of the second RLC entity is comprised is a L2 relay node.

In one embodiment, a node in which the peer RLC entity of the second RLC entity is comprised is a L2 relay node for data unit(s) of the first PDCP entity.

In one embodiment, the first time length is directly proportional to a number of L2 relay node(s) comprised within a distance from a node in which the peer RLC entity of the second RLC entity is comprised to a destination/target receiver of the first data unit set.

In one embodiment, the first processor receives a first indication from a second RLC entity, the first indication being used for acknowledging a successful transmission of a first data unit subset; herein, the second data unit set comprises at least one data unit in the first data unit subset, the first data unit set comprising the first data unit subset; herein, the first indication is a latest indication received before it is determined that the second link is failed.

In one embodiment, the first processor receives a first indication from a second RLC entity, the first indication being used for acknowledging a successful transmission of a first data unit subset; herein, the second data unit set comprises at least one data unit in the first data unit subset, the first data unit set comprising the first data unit subset; herein, the at least one data unit in the first data unit subset comprised by the second data unit set is/are data unit(s) of which a sequence number acknowledged by the first indication is greater than a difference between a value of TX_NEXT and a first Window Size.

In one embodiment, the TX_NEXT indicates a COUNT value of a next data unit to be transmitted.

In one embodiment, the COUNT value is composed of a HFN and a sequence number of data units. Herein, the HFN is a Hyper Frame Number.

In one embodiment, the sequence number is a PDCP sequence number.

In one embodiment, the first window size is configurable.

In one embodiment, the first window size is configured by a serving cell of the first node.

In one embodiment, the first window size is preconfigured.

In one embodiment, the first window size is variable.

In one embodiment, the first window size is fixed.

In one embodiment, a discardTimer corresponding to each data unit in the second data unit set is not expired.

In one embodiment, upon reception of a PDCP SDU from upper layers, the first PDCP entity is a discardTimer that the PDCP SDU begins to be associated with.

In one embodiment, the discardTimer is maintained in a PDCP sublayer.

In one embodiment, the first link is a direct path, while the second link is an indirect path.

In one embodiment, the direct path refers to that data is transmitted only through an air interface between a source node and a destination/target receiver.

In one embodiment, the direct path only includes an uplink.

In one embodiment, the direct path only includes a Uu air interface.

In one embodiment, the indirect path refers to that data is transmitted through at least two air interfaces between a source node and a destination/target receiver.

In one embodiment, the at least two air interfaces include a Uu air interface and a PC5 air interface.

In one embodiment, the at least two air interfaces include at least two PC5 air interfaces.

In one embodiment, the indirect path includes at least one sidelink.

In one embodiment, the indirect path includes at least one sidelink and one uplink.

In one embodiment, the at least two air interfaces include a backhaul (BH) air interface and an Access air interface.

In one embodiment, the first RLC entity is identified by a first logical channel identifier at the network side, and a path transmitting through the first RLC entity is a direct path.

In one embodiment, the second RLC entity is identified by a first RLC channel identifier at the network side, and a path transmitting through the second RLC entity is an indirect path.

In one subembodiment, the first RLC channel identifier is configured by a serving base station of the first node.

In one embodiment, the second RLC entity is identified by a second logical channel identifier at the PC5 air interface, the second logical channel identifier being configured by the first node itself.

In one embodiment, the first RLC entity is a Uu RLC entity.

In one embodiment, the second RLC entity is a sidelink RLC entity.

In one embodiment, that the second link is failed includes at least one of the first sidelink being failed or a third link being failed; herein, the third link is a link included in the second link other than the first sidelink.

In one embodiment, the second link consists of the first sidelink and the third link.

In one embodiment, the second link includes a first sidelink and a third link; the first node transmits data to a L2 U2N relay UE via the first sidelink, and the L2 U2N relay UE forwards the data to a destination/target receiver via the third link.

In one embodiment, the third link is an uplink, and the destination/target receiver is a network device.

In one embodiment, the third link is a sidelink, and the destination/target receiver is a UE.

In one embodiment, the third link is a PUSCH.

In one embodiment, the third link is a PSSCH.

In one embodiment, the second link comprises a PSSCH and a PUSCH.

In one embodiment, the first processor determines that the second link is failed.

In one embodiment, when the second RLC entity indicates a maximum number of retransmissions being reached for the third node in the present application, it is determined that the second link is failed.

In one embodiment, when a T400 for the third node in the present application expires, it is determined that the second link is failed.

In one embodiment, when a Medium Access Control (MAC) entity indicates that a maximum number of Hybrid Automatic Repeat Request (HARQ) Discontinuous Transmissions (DTX) is reached for the third node in the present application, it is determined that the second link is failed; herein, the MAC entity is maintained in the first node.

In one subembodiment of the above three embodiments, a cause of that the second link is failed is that the first sidelink is failed.

In one embodiment, when a first notification is received from the third node in the present application and the first notification comprises an indication Type, it is determined that the second link is failed.

In one subembodiment of the above embodiment, a cause of that the second link is failed is that the third link is failed.

In one embodiment, the first notification is used for indicating that a Uu radio link failure occurs in the third node in the present application.

In one embodiment, the first notification is used for indicating that an RRC reconfiguration message that comprises reconfigurationWithSync is received by the third node in the present application.

In one embodiment, the first notification is used for indicating that cell reselection occurs in the third node in the present application.

In one embodiment, the first notification is used for indicating that an RRC connection failure occurs in the third node in the present application, including an RRC connection reject, an RRC resume failure and an expiration of a timer T300.

In one embodiment, the first notification is a NotificationMessageSidelink.

In one embodiment, the indication type is a relayUE-UuRLF.

In one embodiment, the indication type is a relayUE-HO.

In one embodiment, the indication type is a relayUE-CellReselection.

In one embodiment, the indication type is a relayUE-UuRRCFailure.

In one embodiment, when the second link is not failed, data unit(s) of the first PDCP entity is(are) transmitted through the second RLC entity; when the second link is failed, data unit(s) of first PDCP entity starts/start to be transmitted through the first RLC entity.

### Embodiment 6

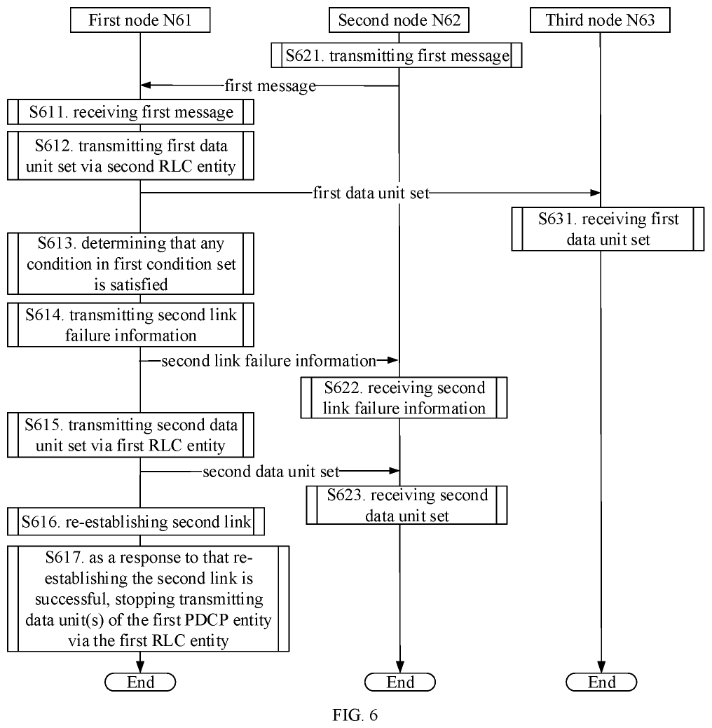

Embodiment 6 illustrates a flowchart of radio signal transmission according to one embodiment of the present application, as shown in FIG. 6. In FIG. 6, a first node N61 and a second node N62 are in communication via a Uu air interface, the first node N61 and a third node N63 are in communication via a PC5 air interface, while the third node N63 and the second node N62 are in communication via a Uu air interface.

The first node N61 receives a first message in step S611; and transmits a first data unit set via a second RLC entity in step S612; and determines that any condition in a first condition set is satisfied in step S613; transmits second link failure information in step S614; and transmits a second data unit set via a first RLC entity in step S615; re-establishes a second link in step S616; and in step S617, as a response to that re-establishing the second link is successful, stops transmitting data unit(s) of the first PDCP entity via the first RLC entity.

The second node N62 receives second link failure information in step S621; and receives a second data unit set in step S622.

The third node N63 receives a first data unit set in step S631.

Steps taken in Embodiment 6 are applicable to scenarios where the condition that a second link is failed is satisfied.

It should be noted that although not shown in FIG. 6, data unit(s) in the first data unit set that has/have been successfully received by the third node is(are) forwarded to the second node via the third node; herein, the second node is a destination/target receiver of the first data unit set.

It should be noted that although not shown in FIG. 6, the step S616 contains information interaction between the first node and the second node.

In Embodiment 6, receiving a first message, the first message being used for configuring a first RLC entity and a second RLC entity; and transmitting a first data unit set via the second RLC entity; and as a response to any condition in a first condition set being satisfied, starting to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink; when the second link is failed, transmitting second link failure information via the first link, the second link failure information indicating the second RLC entity; when the second link is failed, re-establishing the second link; and as a response to that re-establishing the second link is successful, stopping transmitting data unit(s) comprised by the first PDCP entity via the first RLC entity.

In one embodiment, the first node is a UE.

In one embodiment, the second node is a base station for a serving cell of the first node.

In one embodiment, the second node is a base station for a primary cell (PCell) of the first node.

In one embodiment, the second node is a base station for a secondary cell (SCell) of the first node.

In one embodiment, the second node is a base station for a camping cell of the first node.

In one embodiment, the third node is a L2 U2N relay UE.

In one embodiment, when the second link is failed, transmitting second link failure information via the first link.

In one embodiment, the phrase of transmitting second link failure information via the first link means: transmitting the second link failure information via a direct path.

In one embodiment, the phrase of transmitting second link failure information through the first link means: transmitting the second link failure information through a Dedicated Control Channel (DCCH).

In one embodiment, the phrase of transmitting second link failure information via the first link means: transmitting the second link failure information through a PUSCH.

In one embodiment, the phrase of transmitting second link failure information through the first link means: transmitting the second link failure information via a Uu air interface.

In one embodiment, the second link failure information is carried in a VarRLF-Report.

In one embodiment, the second link failure information is carried in FailureInformation.

In one embodiment, the second link failure information is carried in a UL-DCCH-Message.

In one embodiment, the second link failure information indicates the second RLC entity.

In one embodiment, the second link failure information comprises the first RLC channel identifier, the first RLC channel identifier being used to indicate the second RLC entity.

In one embodiment, the second link failure information comprises a first radio bearer identifier, the first radio bearer identifier being used to indicate a first radio bearer, where data of the first radio bearer is transmitted through the first PDCP entity.

In one embodiment, the second link failure information comprises the third node identity, the third node identity being used for identifying a node in which a peer RLC entity of the second RLC entity is comprised.

In one embodiment, the third node identity is a Link layer Identity.

In one embodiment, the third node identity is a local Identity.

In one embodiment, when it is determined that a cause of the second link being failed is that the first sidelink is failed, the second link failure information indicates that a type of the second link failure is a sl-rlf.

In one embodiment, when it is determined that a cause of the second link being failed is that the third link is failed, the second link failure information indicates that a type of the second link failure is a Uu-rlf.

In one embodiment, when the second link is failed, re-establishing the second link.

In one embodiment, the phrase of re-establishing the second link comprises: the first node choosing at least one candidate relay node.

In one embodiment, the phrase of re-establishing the second link comprises: transmitting a message via the first link for indicating the at least one candidate relay node.

In one embodiment, the phrase of re-establishing the second link comprises: receiving a message via the first link for indicating a fourth node, the fourth node being one of the at least one candidate relay node, where the fourth node is either the third node or is a relay node other than the third node.

In one embodiment, the phrase of re-establishing the second link comprises: establishing a PC5 connection with the fourth node.

In one embodiment, the phrase of re-establishing the second link comprises: receiving an RRC reconfiguration message via the first link, the RRC reconfiguration message indicating a second RLC channel, the second RLC channel being associated with a third RLC entity; data unit(s) comprised by the third RLC entity being transmitted via a second sidelink in an air interface, where the third RLC entity is associated with the first PDCP entity.

In one embodiment, the phrase of re-establishing the second link comprises: the first PDCP entity not being re-established.

In one embodiment, the phrase of re-establishing the second link comprises: the security key for the first PDCP entity not being updated.

In one embodiment, as a response to that re-establishing the second link is successful, stopping transmitting data unit(s) comprised by the first PDCP entity via the first RLC entity.

In one embodiment, when the RRC reconfiguration message received via the first link comprises a configuration message of a L2 U2N remote UE, it is determined that re-establishing the second link is successful.

In one embodiment, when the RRC reconfiguration message received via the first link at least comprises a Sidelink Relay Adaptation Protocol (SRAP) configuration, it is determined that re-establishing the second link is successful.

In one embodiment, when the RRC reconfiguration message received via the first link at least comprises a SL-SRAP-Config IE, it is determined that re-establishing the second link is successful.

In one embodiment, when transmitting an RRC reconfiguration success message, it is determined that re-establishing the second link is successful; herein, the RRC reconfiguration success message is a response to an RRC reconfiguration message that comprises a configuration message of a L2 U2N remote UE.

In one embodiment, the phrase of stopping transmitting data unit(s) comprised by the first PDCP entity via the first RLC entity means to start to transmit data unit(s) comprised by the first PDCP entity via the third RLC entity.

In one embodiment, the phrase of stopping transmitting data unit(s) comprised by the first PDCP entity via the first RLC entity means to start to transmit data unit(s) comprised by the first PDCP entity via a re-established second link.

In one embodiment, the phrase of stopping transmitting data unit(s) comprised by the first PDCP entity via the first RLC entity means to start to transmit data unit(s) comprised by the first PDCP entity via an indirect path.

In one embodiment, the phrase of stopping transmitting data unit(s) comprised by the first PDCP entity via the first RLC entity means that the first RLC entity is pending.

In one embodiment, the phrase of stopping transmitting data unit(s) comprised by the first PDCP entity via the first RLC entity means that the first RLC entity enters a dormant state.

In one embodiment, the phrase of stopping transmitting data unit(s) comprised by the first PDCP entity via the first RLC entity means that the first RLC entity is deactivated.

In one embodiment, the phrase of stopping transmitting data unit(s) comprised by the first PDCP entity via the first RLC entity means that the first PDCP entity is switched to a new path.

### Embodiment 7

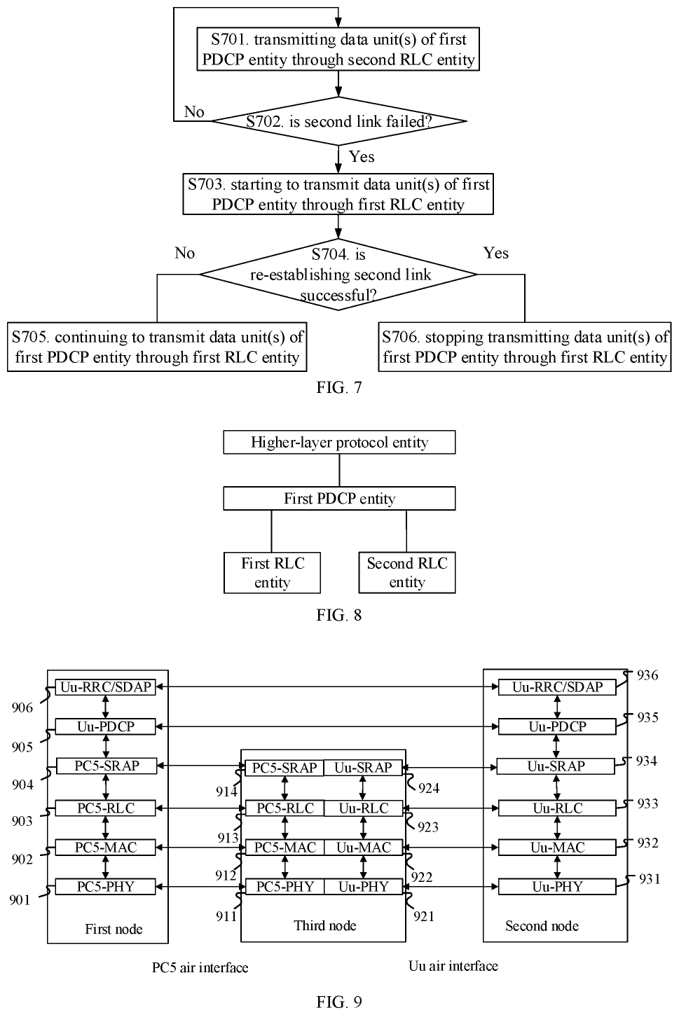

Embodiment 7 illustrates a third flowchart of signal transmission of a first node according to one embodiment of the present application, as shown in FIG. 7.

In FIG. 7, transmitting data unit(s) of a first PDCP entity through a second RLC entity in step S701; determining whether a second link is failed in step S702, if so, performing step S703; if not, skip back to step S701; starting to transmit data unit(s) of a first PDCP entity through a first RLC entity in step S703; and determining whether re-establishing a second link is successful in step S704, if so, performing step S706; if not, performing step S705; continuing to transmit data unit(s) of a first PDCP entity through a first RLC entity in step S705; and stopping transmitting data unit(s) of a first PDCP entity through a first RLC entity in step S706.

### Embodiment 8

Embodiment 8 illustrates a schematic diagram of protocol structures of a first PDCP entity, a first RLC entity and a second RLC entity according to one embodiment of the present application, as shown in FIG. 8. In FIG. 8, a first PDCP entity, a first RLC entity and a second RLC entity are all located in a first node, where the first PDCP entity and the first RLC entity are in communication via an inter-layer interface, and the first PDCP entity and the second RLC entity are in communication via an inter-layer interface.

In one embodiment, FIG. 8 is applicable to SRB.

In one embodiment, FIG. 8 is applicable to DRB.

In one embodiment, FIG. 8 is applicable to MRB.

In one embodiment, the protocol structure illustrated by FIG. 8 is used for a first radio bearer.

In one embodiment, the first radio bearer is a signaling radio bearer (SRB).

In one embodiment, the first radio bearer is a data radio bearer (DRB).

In one embodiment, the first radio bearer is an MBS radio bearer (MRB).

In one embodiment, the first radio bearer is a multi-path DRB.

In one embodiment, the first radio bearer is a MC DRB, i.e., a multi-connectivity DRB.

In one embodiment, the first radio bearer is a DC DRB, i.e., a dual-connectivity DRB.

In one embodiment, the first radio bearer is a sidelink DRB.

In one embodiment, the first message comprises the first radio bearer identifier, the first PDCP entity being used for the first radio bearer.

In one embodiment, the first message comprises the first radio bearer identifier, the first RLC entity and the second RLC entity respectively serving the first radio bearer.

In one embodiment, FIG. 8 is applicable to transceiving.

In one embodiment, a higher-layer protocol entity in FIG. 8 is RRC, where the FIG. 8 is for SRB.

In one embodiment, a higher-layer protocol entity in FIG. 8 is SDAP, where the FIG. 8 is for DRB or MRB.

In one embodiment, the first PDCP entity is used for transmitting data of the first radio bearer.

In one embodiment, a radio bearer served by the first RLC entity and the second RLC entity is the first radio bearer, where the first PDCP entity is used for transmitting data of the first radio bearer.

In one embodiment, data unit(s) of the first PDCP entity is(are) transmitted by the first RLC entity or the second RLC entity.

In one embodiment, when none of conditions in the first condition set is satisfied, data unit(s) of the first PDCP entity is(are) transmitted by the second RLC entity, the second RLC entity belonging to an indirect path; data unit(s) of the first PDCP entity is(are) not transmitted by the first RLC entity, the first RLC entity belonging to a direct path.

In one embodiment, when any condition in the first condition set is satisfied, data unit(s) of the first PDCP entity starts/start to be transmitted by the first RLC entity, the first RLC entity belonging to a direct path.

In one embodiment, the direct path is used for data transmission in a control plane, while the indirect path is used for data transmission in a data plane.

In one embodiment, the data transmission in the control plane includes a message transmission of an RRC sublayer.

In one embodiment, a PDCP PDU formed by a data packet received from a higher-layer protocol entity being processed by the first PDCP is transmitted by either the first RLC entity or the second RLC entity; herein, the higher-layer protocol entity is an RRC protocol entity or an SDAP protocol entity.

In one embodiment, the first RLC entity is for uplink communications, while the second RLC entity is for sidelink communications.

In one embodiment, the first RLC entity and the second RLC entity are both for sidelink communications.

In one embodiment, the first RLC entity and the second RLC entity are both for a Master Cell Group (MCG).

In one embodiment, the first RLC entity and the second RLC entity are both for a Secondary Cell Group (SCG).

In one embodiment, in a dual connectivity transmission, the first RLC entity is used for data transmission on a primary path; the second RLC entity is used for data transmission on a secondary path.

In one subembodiment, the first RLC entity is a primary RLC entity, and the second RLC entity is a secondary RLC entity.

In one embodiment, in a dual connectivity transmission, the first RLC entity is used for data transmission on a secondary path, while the second RLC entity is used for data transmission on a primary path.

In one subembodiment, the first RLC entity is a secondary RLC entity, and the second RLC entity is a primary RLC entity.

In one subembodiment, when the second link is failed, the first RLC entity is configured as a primary RLC entity.

In one subembodiment, when re-establishing the second link is successful, the first RLC entity is configured as a secondary RLC entity.

In one embodiment, the primary RLC entity is configurable.

In one embodiment, the primary RLC entity is associated with one cell group.

In one embodiment, the cell group is one of a master cell group (MCG) or a secondary cell group (SCG).

In one embodiment, the first RLC entity is used for data transmission on a Uu air interface, while the second RLC entity is used for data transmission on a PC5 air interface.

In one embodiment, the first radio bearer is an uplink radio bearer.

In one embodiment, the first radio bearer is a Sidelink Radio Bearer (SLRB).

### Embodiment 9

Embodiment 9 illustrates a schematic diagram of a radio protocol architecture of relay transmission according to one embodiment of the present application, as shown in FIG. 9.

In FIG. 9, in a relay transmission, take an instance of data being transmitted from the first node to a second node via a third node as an example (similarly for an instance of data being transmitted from the second node to the first node via a third node): First target data is sequentially processed by a Uu-PDCP sublayer 905, a Sidelink Relay Adaptation Protocol (PC5-SRAP) sublayer 904 and a PC5-RLC sublayer 903 at the first node side for generating a first target MAC PDU at a PC5-MAC sublayer 902, which is then conveyed to a PC5-PHY layer 901, and transmitted to a PC5-PHY layer 911 of the third node via a PC5 air interface, and afterwards is processed by a PC5-MAC sublayer 912 and a PC5-RLC sublayer 913 for recovering first RLC data; the first RLC data is processed by a PC5-SRAP sublayer 914 and a Uu-SRAP sublayer 924 for re-generating second RLC data at a Uu-RLC sublayer 923, which after being processed by a Uu-MAC sublayer 922 generates a second target MAC PDU to be conveyed to a Uu-PHY layer 921; next, the second target MAC PDU is transmitted to a Uu-PHY layer 931 of the second node via a Uu air interface, and then to a Uu-MAC sublayer 932 to recover a second target MAC PDU, which sequentially goes through the processing of a Uu-RLC sublayer 933, a Uu-SRAP sublayer 934 and a Uu-PDCP sublayer 935 for recovering first target data.

The third node in FIG. 9 is a L2 U2N relay node.

In FIG. 9, data forwarded by the third node is processed by a MAC sublayer, an RLC sublayer and an SRAP sublayer instead of a PDCP sublayer; the PC5 air interface is an air interface between the first node and the third node, where PC5 interface-related protocol entities PC5-SRAP904 and PC5-SRAP914, PC5-RLC903 and PC5-RLC913, PC5-MAC902 and PC5-MAC912 as well as PC5-PHY901 and PC5-PHY911 are respectively terminated at the first node and the third node; the Uu air interface is an air interface between the third node and the second node, where protocol entities for the Uu air interface, namely Uu-SRAP924 and Uu-SRAP934, Uu-RLC923 and Uu-RLC933, Uu-MAC922 and Uu-MAC932, as well as Uu-PHY921 and Uu-PHY931 are respectively terminated at the third node and the second node. protocol entities Uu-RRC/SDAP906 and Uu-RRC/SDAP936, as well as Uu-PDCP905 and Uu-PDCP935 at higher-layers are respectively terminated at the first node and the second node.

In one embodiment, FIG. 9 is a radio protocol architecture of each node on the second link.

In one embodiment, a radio protocol architecture of each node on the first link corresponds to FIG. 3.

In one embodiment, the PC5-SRAP904 is a peer SRAP entity of the PC5-SRAP914.

In one embodiment, the Uu-SRAP924 is a peer SRAP entity of the Uu-SRAP934.

In one embodiment, the PC5-RLC903 is a peer RLC entity of the PC5-RLC913.

In one embodiment, the Uu-RLC923 is a peer RLC entity of the Uu-RLC933.

In one embodiment, the Uu-PDCP905 is a peer PDCP entity of the Uu-PDCP935.

In one embodiment, the first PDCP entity is the Uu-PDCP905, the second RLC entity is the PC5-RLC903, and a peer RLC entity of the second RLC entity is the PC5-RLC913, where the PC5-RLC903 sends a poll to the PC5-RLC913, the poll being used to trigger a feedback of a STATUS PDU sent by the PC5-RLC913 to the PC5-RLC903; the STATUS PDU is a positive acknowledgement of data unit(s) in the first data unit set having been successfully transmitted, where the PC5-RLC903 transmits a first indication to the Uu-PDCP905.

In one embodiment, the STATUS PDU is used for indicating whether a data unit transmission between the PC5-RLC903 and the PC5-RLC913 is successful.

In one embodiment, the STATUS PDU does not indicate whether a data unit transmission between the

Uu-RLC923 and the Uu-RLC933 is successful.

In one embodiment, for a L2 relay transmission, an RLC sublayer, a MAC sublayer and a PHY layer are in charge of point-to-point communication of each hop; a PDCP sublayer and an RRC/SDAP sublayer are in charge of peer-to-peer communication. In one embodiment, the SRAP sublayer determines the UE ID and bearer identifier.

In one embodiment, the SRAP sublayer determines the egress link.

In one embodiment, the SRAP sublayer determines the egress RLC channel.

In one embodiment, the SRAP sublayer implements the Bearer mapping function.

In one embodiment, the SRAP sublayer implements the Routing function.

In FIG. 9, the Routing function sends a packet from the first node to the second node.

In FIG. 9, the second node is an NG-RAN node, and the first node is a UE.

In one embodiment, the first node in FIG. 9 corresponds to the UE201 in Embodiment 2.

In one embodiment, the third node in FIG. 9 corresponds to the UE241 in Embodiment 2.

In one embodiment, the second node in FIG. 9 corresponds to the gNB203 in Embodiment 2.

### Embodiment 10

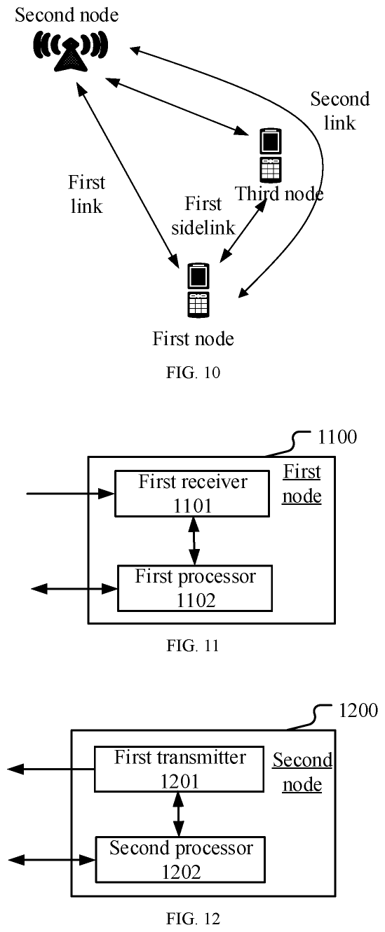

Embodiment 10 illustrates a schematic diagram of a topological structure according to one embodiment of the present application, as shown in FIG. 10.

In one embodiment, the first link is a link between the first node and the second node.

In one embodiment, the first sidelink is a link between the first node and the third node.

In one embodiment, the second link consists of the first sidelink and a link between the third node and the second node.

In one embodiment, the third node is a L2 relay node.

In one embodiment, the third node is a L2 U2N relay UE.

In one embodiment, the third node and the first node belong to a same cell group.

In one embodiment, the third node and the first node belong to different cell groups.

In one embodiment, the second node is a NG-RAN node.

In one embodiment, the first node in FIG. 10 corresponds to the UE201 in Embodiment 2.

In one embodiment, the third node in FIG. 10 corresponds to the UE241 in Embodiment 2.

In one embodiment, the second node in FIG. 10 corresponds to the gNB203 in Embodiment 2.

### Embodiment 11

Embodiment 11 illustrates a structure block diagram of a processing device in a first node according to one embodiment of the present application, as shown in FIG. 11.

In FIG. 11, a processing device 1100 in the first node comprises a first receiver 1101 and a first processor 1102. The first node 1100 is a UE.

In Embodiment 11, the first receiver 1101 receives a first message, the first message being used for configuring a first RLC entity and a second RLC entity; and the first processor 1102 transmits a first data unit set via the second RLC entity; as a response to any condition in a first condition set being satisfied, starts to transmit a second data unit set via the first RLC entity; herein, each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the first message indicates a first logical channel and a first RLC channel, where the first logical channel is associated with the first RLC entity, while the first RLC channel is associated with the second RLC entity.

In one embodiment, the first processor 1102 receives a first indication from the second RLC entity, the first indication being used for acknowledging a successful transmission of a first data unit subset; herein, the second data unit set comprises at least one data unit in the first data unit subset, the first data unit set comprising the first data unit subset.

In one embodiment, the first processor 1102 receives a first indication from the second RLC entity, the first indication being used for acknowledging a successful transmission of a first data unit subset; herein, the second data unit set comprises at least one data unit in the first data unit subset, the first data unit set comprising the first data unit subset; a time interval from a reception of the first indication to the second link being acknowledged as failed is smaller than a first time length.

In one embodiment, the first processor 1102, when the second link is failed, transmits second link failure information via the first link, the second link failure information indicating the second RLC entity.

In one embodiment, the first processor 1102, when the second link is failed, re-establishes the second link; and as a response to that re-establishing the second link is successful, stops transmitting data unit(s) comprised by the first PDCP entity via the first RLC entity.

In one embodiment, the first link is a direct path, while the second link is an indirect path; that the second link is failed includes at least one of the first sidelink being failed or a third link being failed; herein, the third link is a link included in the second link other than the first sidelink.

In one embodiment, the first receiver 1101 comprises the receiver 454 (comprising the antenna 452), the receiving processor 456, the multi-antenna receiving processor 458 and the controller/processor 459 in FIG. 4 of the present application.

In one embodiment, the first receiver 1101 comprises at least one of the receiver 454 (comprising the antenna 452), the receiving processor 456, the multi-antenna receiving processor 458 or the controller/processor 459 in FIG. 4 of the present application.

In one embodiment, the first receiver 1101 comprises the controller/processor 459 in FIG. 4 of the present application.

In one embodiment, the first processor 1102 comprises the receiver 454 (comprising the antenna 452), the receiving processor 456, the multi-antenna receiving processor 458 and the controller/processor 459 in FIG. 4 of the present application.

In one embodiment, the first processor 1102 comprises at least one of the receiver 454 (comprising the antenna 452), the receiving processor 456, the multi-antenna receiving processor 458 or the controller/processor 459 in FIG. 4 of the present application.

In one embodiment, the first processor 1102 comprises the transmitter 454 (comprising the antenna 452), the transmitting processor 468, the multi-antenna transmitting processor 457 and the controller/processor 459 in FIG. 4 of the present application.

In one embodiment, the first processor 1102 comprises at least one of the transmitter 454 (comprising the antenna 452), the transmitting processor 468, the multi-antenna transmitting processor 457 or the controller/processor 459 in FIG. 4 of the present application.

In one embodiment, the first processor 1102 comprises the controller/processor 459 in FIG. 4 of the present application.

### Embodiment 12

Embodiment 12 illustrates a structure block diagram of a processing device in a second node according to one embodiment of the present application, as shown in FIG. 12. In FIG. 12, a processing device 1200 in the second node comprises a first transmitter 1201 and a second processor 1202; the second node 1200 is a base station.

In Embodiment 12, the first transmitter 1201 transmits a first message, the first message being used for configuring a first RLC entity and a second RLC entity; herein, a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

In one embodiment, the first message indicates a first logical channel and a first RLC channel, where the first logical channel is associated with the first RLC entity, while the first RLC channel is associated with the second RLC entity.

In one embodiment, a first indication from the second RLC entity is received, the first indication being used for acknowledging a successful transmission of a first data unit subset; herein, the second data unit set comprises at least one data unit in the first data unit subset, the first data unit set comprising the first data unit subset.

In one embodiment, a first indication from the second RLC entity is received, the first indication being used for acknowledging a successful transmission of a first data unit subset; herein, the second data unit set comprises at least one data unit in the first data unit subset, the first data unit set comprising the first data unit subset; a time interval from a reception of the first indication to the second link being acknowledged as failed is smaller than a first time length.

In one embodiment, the second processor 1202, when the second link is failed, receives second link failure information via the first link, the second link failure information indicating the second RLC entity.

In one embodiment, the second processor 1202, when re-establishing the second link is successful, stops receiving data unit(s) comprised by the first PDCP entity via a peer RLC entity of the first RLC entity; herein, the second link is failed and the second link is re-established.

In one embodiment, the first link is a direct path, while the second link is an indirect path; that the second link is failed includes at least one of the first sidelink being failed or a third link being failed; herein, the third link is a link included in the second link other than the first sidelink.

In one embodiment, the first transmitter 1201 comprises the transmitter 418 (comprising the antenna 420), the transmitting processor 416, the multi-antenna transmitting processor 471 and the controller/processor 475 in FIG. 4 of the present application.

In one embodiment, the first transmitter 1201 comprises at least one of the transmitter 418 (comprising the antenna 420), the transmitting processor 416, the multi-antenna transmitting processor 471 or the controller/processor 475 in FIG. 4 of the present application.

In one embodiment, the second processor 1202 comprises the transmitter 418 (comprising the antenna 420), the transmitting processor 416, the multi-antenna transmitting processor 471 and the controller/processor 475 in FIG. 4 of the present application.

In one embodiment, the second processor 1202 comprises at least one of the transmitter 418 (comprising the antenna 420), the transmitting processor 416, the multi-antenna transmitting processor 471 or the controller/processor 475 in FIG. 4 of the present application.

In one embodiment, the second processor 1202 comprises the transmitter 418 (comprising the antenna 420), the receiving processor 470, the multi-antenna receiving processor 472 and the controller/processor 475 in FIG. 4 of the present application.

In one embodiment, the second processor 1202 comprises at least one of the transmitter 418 (comprising the antenna 420), the receiving processor 470, the multi-antenna receiving processor 472 or the controller/processor 475 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first-type communication node or UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The second-type communication node or base station or network-side device in the present application includes but is not limited to macro-cellular base stations, micro-cellular base stations, home base stations, relay base station, eNB, gNB, Transmitter Receiver Point (TRP), relay satellite, satellite base station, airborne base station, test equipment like transceiving device simulating partial functions of base station or signaling tester and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first receiver, receiving a first message, the first message being used for configuring a first RLC entity and a second RLC entity; and
a first processor, transmitting a first data unit set via the second RLC entity; and as a response to any condition in a first condition set being satisfied, starting to transmit a second data unit set via the first RLC entity;
wherein each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

2. The first node according to claim 1, characterized in that the first message indicates a first logical channel and a first RLC channel, where the first logical channel is associated with the first RLC entity, while the first RLC channel is associated with the second RLC entity.

3. The first node according to claim 1, characterized in comprising:
the first processor, receiving a first indication from the second RLC entity, the first indication being used for acknowledging a successful transmission of a first data unit subset;
wherein the second data unit set comprises at least one data unit in the first data unit subset, the first data unit set comprising the first data unit subset.

4. The first node according to claim 3, characterized in that a time interval from a reception of the first indication to the second link being acknowledged as failed is smaller than a first time length;
wherein the first time length is configurable, or, the first time length is pre-configured.

5. The first node according to claim 1, characterized in comprising:
the first processor, when the second link is failed, transmitting second link failure information via the first link, the second link failure information indicating the second RLC entity.

6. The first node according to claim 1, characterized in comprising:
the first processor, when the second link is failed, re-establishing the second link; and as a response to that re-establishing the second link is successful, stopping transmitting data unit(s) comprised by the first PDCP entity via the first RLC entity.

7. The first node according to claim 1, characterized in that the first link is a direct link, while the second link is an indirect link; that the second link is failed includes at least one of the first sidelink being failed or a third link being failed;
wherein the third link is a link included in the second link other than the first sidelink.

8. A second node wireless communications, comprising:
a first transmitter, transmitting a first message, the first message being used for configuring a first RLC entity and a second RLC entity;
wherein a first data unit set is transmitted via the second RLC entity; when any condition in a first condition set is satisfied, a second data unit set starts to be transmitted via the first RLC entity; each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

9. The second node according to claim 8, characterized in that the first message indicates a first logical channel and a first RLC channel, where the first logical channel is associated with the first RLC entity, while the first RLC channel is associated with the second RLC entity.

10. The second node according to claim 8, characterized in that a first indication from the second RLC entity is received, the first indication being used for acknowledging a successful transmission of a first data unit subset;
wherein the second data unit set comprises at least one data unit in the first data unit subset, the first data unit set comprising the first data unit subset.

11. The second node according to claim 10, characterized in that a time interval from a reception of the first indication to the second link being acknowledged as failed is smaller than a first time length;
wherein the first time length is configurable, or, the first time length is pre-configured.

12. The second node according to claim 8, characterized in comprising:
a second processor, when the second link is failed, receiving second link failure information via the first link, the second link failure information indicating the second RLC entity.

13. The second node according to claim 8, characterized in comprising:
a second processor, when re-establishing the second link is successful, stopping receiving data unit(s) comprised by the first PDCP entity via a peer RLC entity of the first RLC entity;
wherein the second link is failed and the second link is re-established.

14. The second node according to claim 8, characterized in that the first link is a direct link, while the second link is an indirect link; that the second link is failed includes at least one of the first sidelink being failed or a third link being failed;
wherein the third link is a link included in the second link other than the first sidelink.

15. A method in a first node for wireless communications, characterized in comprising:
receiving a first message, the first message being used for configuring a first RLC entity and a second RLC entity; and
transmitting a first data unit set via the second RLC entity; and
as a response to any condition in a first condition set being satisfied, starting to transmit a second data unit set via the first RLC entity;
wherein each of the first data unit set and the second data unit set respectively comprises at least one data unit; each data unit comprised by the second RLC entity is transmitted via a second link in an air interface; the first condition set comprises that the second link is failed; each data unit comprised by the first RLC entity is transmitted via a first link in an air interface; the first RLC entity and the second RLC entity are associated with a first PDCP entity, the first PDCP entity comprising the first data unit set and the second data unit set; the second link includes a first sidelink.

16. The method in the first node according to claim 15, characterized in that the first message indicates a first logical channel and a first RLC channel, where the first logical channel is associated with the first RLC entity, while the first RLC channel is associated with the second RLC entity.

17. The method in the first node according to claim 15, characterized in comprising:
receiving a first indication from the second RLC entity, the first indication being used for acknowledging a successful transmission of a first data unit subset;
wherein the second data unit set comprises at least one data unit in the first data unit subset, the first data unit set comprising the first data unit subset.

18. The method in the first node according to claim 17, characterized in that a time interval from a reception of the first indication to the second link being acknowledged as failed is smaller than a first time length;
wherein the first time length is configurable, or, the first time length is pre-configured.

19. The method in the first node according to claim 15, characterized in comprising:
when the second link is failed, transmitting second link failure information via the first link, the second link failure information indicating the second RLC entity.

20. The method in the first node according to claim 15, characterized in comprising:
when the second link is failed, re-establishing the second link; and as a response to that re-establishing the second link is successful, stopping transmitting data unit(s) comprised by the first PDCP entity via the first RLC entity.
